(19) United States
(12) Patent Application Publication
(10) Pub. No.: US 2026/0191249 A1
(43) Pub. Date: Jul. 9, 2026

(54) COATING COMPOSITION FOR BAKING PAPER, COATED BAKING PAPER, METHOD FOR MAKING SAID BAKING PAPER, AND USE OF SAID COATED BAKING PAPER

(71) Applicant: HEIWEI B.V., Harlingen (NL)

(72) Inventor: Sierk Laurentius Michael Van Der Heide, Harlingen (NL)

(21) Appl. No.: 18/868,621

(22) PCT Filed: May 23, 2023
(86) PCT No.: PCT/NL2023/050296

§ 371 Date: Nov. 22, 2024

(30) Foreign Application Priority Data
May 24, 2022 (NL) 2031979

(51) Int. Cl. A23P 20/12; A23L 21/25; A23L 29/212; A23L 29/269; D21H 19/12; D21H 19/82

(52) U.S. Cl. CPC A23P 20/12; A23L 21/25; A23L 29/212; A23L 29/272; D21H 19/12; D21H 19/828

(57) ABSTRACT

The invention relates to a coating composition for baking paper, a coated baking paper comprising said coating composition, a method for making coated baking paper, and use of said coated baking paper, for example to provide images, text, and the like to edible products. The coating composition comprises fat, amorphous starch, sugar and/or sugar substituent, emulsifier, and wax.

The present invention relates to a coating composition for baking paper, a coated baking paper comprising said coating composition, a method for making coated baking paper, and use of said coated baking paper.

To provide images, text, and the like to edible products a transfer sheet may be used. Conventional sheets used to transfer images, text, and the like to edible products are often made of plastic. After use said plastic is disposed and may contribute to the undesired amount of plastic waste.

Another option to provide images, text, and the like to edible products is to use a transfer sheet of cellulose or chocolate. A disadvantage of these type of transfer sheets is that they are designed for a single use. Furthermore, said sheets are fragile and may break easily. Therefore, sheets of cellulose or chocolate are less suitable for use in a production environment.

These problems prevent an efficient and effective transfer sheet for images and test and the like. This problem is even bigger for large scale use of the transfer sheets.

The present invention aims at obviating or at least reducing the aforementioned problems and to enable efficient and effective transfer of images and text and the like to an edible substrate.

This objective is achieved with a coating composition for baking paper, comprising fat, amorphous starch, sugar and/or sugar substituent, emulsifier, and wax.

It is noted that the coating composition according to the invention may be used for coating baking paper. Said paper is based on a cellulose based composite which has been processed to give it additional properties like non-stickiness, grease resistance, and resistance to humidity.

Furthermore, throughout this application, baking paper may also be referred to as parchment paper, vegetable parchment, or waxed paper.

It is also noted that throughout this application amorphous starch may refer to starch which is fermented. Thus, the starch provided to the coating composition according to the invention is fermented. In other words, starch is initially added to the coating composition, which is then fermented to form amorphous starch.

The coating composition according to the invention is suitable for human consumption. Therefore, the coating composition according to the invention may be used in edible products, or used to provide, for example, a print to an edible product. The coating composition according to the invention may for example be provided to baking paper, such that the baking paper is enabled to be used as transfer sheet/carrier of a print to an edible product.

Therefore, an advantage of the coating composition according to the invention is that it enables a sustainable and flexible transfer sheet of a print to an edible product. In fact, the coating composition according to the invention reduces the amount of plastic used in the production of transfer sheets.

In addition, the coating composition according to the invention also enables the use of a robust transfer sheet for a print to an edible product. In fact, the coating composition according to the invention enables a transfer sheet which is flexible. As a result, the coating composition according to the invention enables to provide a print to curved objects in an efficient and effective manner.

A further advantage of the coating composition according to the invention is that the transfer sheet/carrier comprising a print to be provided to an edible substrate may be reusable. Therefore, less waste is produced.

In addition, the coating composition according to the invention does not stain. Therefore, efficient and effective use of the baking paper as a carrier is achieved.

In a preferred embodiment according to the invention, the coating composition further comprises honey. Preferably, the honey may be nectar honey and/or honeydew honey.

It has been found that honey, preferably nectar honey and/or honeydew honey, more preferably nectar honey, provides an efficient and effective coating composition.

In a preferred embodiment, the nectar honey is fresh nectar honey.

An advantage of the honey is that it may comprise amylase. Without being bound by theory, said amylase may induce or increase the fermentation of the starch and/or amorphous starch.

Furthermore, without being bound by theory, honey passes at least part of the intestines of the animals/insects producing the honey. In said intestines the honey is mixed with, for example, saliva of said animals/insects. The saliva may comprise amylase.

In a further preferred embodiment according to the invention, the coating composition further comprises an amylase. Preferably, wherein the amylase is α-amylase, β-amylase, γ-amylase, or a combination thereof.

It was found that amylase may ferment the starch and/or amorphous starch provided to the coating composition. As a result, an efficient and effective coating composition is achieved, wherein a transfer sheet comprising the coating composition may be used multiple times.

Furthermore, it was found that the coating composition according to the invention preferably has a pH in the range of 3.5 to 7, preferably in the range of 4 to 6, more preferably in the range of 4 to 5. A coating composition according to the invention comprising said pH provides an efficient and effective coating composition.

In further preferred embodiment according to the invention, the coating composition further comprises water. Preferably, the water has a hardness in the range of 1 ppm to 180 ppm, preferably in the range of 1 ppm to 120 ppm, more preferably wherein the water is present in an amount in the range of 50 wt. % to 65 wt. %.

It is noted that ppm refers to parts per million. Furthermore, the hardness of water refers to the amount of minerals dissolved in the water. Said minerals may include calcium carbonate, calcium bicarbonate, sodium carbonate, sodium bicarbonate, potassium carbonate, potassium bicarbonate, magnesium carbonate, and magnesium bicarbonate. The hardness of the water may be determined by ISO/TS 15923-2:2017.

Furthermore, it is noted that throughout this application wt. % refers to weight percentage and that the amount of each individual compound provided to the coating composition is a weight percentage of the total composition. In other words, the amount in weight percentage of water is also defined as an amount of the total coating composition.

In further preferred embodiment according to the invention, the emulsifier comprises lecithin, glycerol, polyoxyethene (8) stearate, polyoxyethene (40) stearate, polyoxyethylene (20) sorbitan monolaurate, polyoxyethylene (20) sorbitan monopalmitate, polyoxyethylene (20) sorbitan monostearate, polyoxyethylene (20) sorbitan monooleate, polyoxyethene (20) sorbitan tristearate, alginic acid, sodium alginate, potassium alginate, ammonium alginate, calcium alginate, propane-1,2-diol alginate, carrageenan, processed eucheuma seaweed, locust bean gum, tragacanth, gum arabic, karaya gum, gellan gum, or a combination thereof. Preferably, a potassium salt of any of the sorbitan compounds is used. For example potassium polyoxyethylene (20) sorbitan monolaurate.

It is noted that glycerol may also be referred to as glycerine.

It was found that any of the above mentioned emulsifiers provides an efficient and effective coating composition.

In a preferred embodiment, the emulsifier may comprise for example polyoxyethylene (20) sorbitan monolaurate. Said emulsifier provides a cost effective coating composition according to the invention.

In further preferred embodiment according to the invention, the amorphous starch comprises an amorphous potato starch and/or an amorphous corn starch and/or amorphous tapioca.

It is noted that corn refers to maize. In other words, amorphous corn starch also includes amorphous maize starch throughout this application.

In a further preferred embodiment according to the invention, the coating composition further comprises a modified starch, preferably wherein the modified starch comprises a phosphate carbamate ester.

Typical starches used as modified starch in the coating composition according to the invention include Amylogum™, Perfectasol™, Etenia™, Solanic 200, Solanic 300, Eliane™, Farinex™, and the like.

Thus, amorphous potato starch originates from potato starch, an amorphous corn starch originates from corn starch, and amorphous tapioca originates from tapioca. In addition, the amorphous character may be achieved by (partly) fermenting the starch.

It was found that phosphated/carbamate ester may effectively be used for coating/lamination of the baking paper.

An advantage of the amorphous starch and/or the modified amorphous starch, is that the stiffness of the baking paper and/or (applied) coating composition is improved. Furthermore, said starch may increase the receptivity of ink.

A further advantage of the amorphous starch and/or modified starch is that excellent printing gloss is achieved, less mottling tendency is achieved, and an excellent binding power is achieved. Thus, said amorphous starch and/or modified starch provides paper stiffness, an excellent printing gloss, and is cost effective.

In further preferred embodiment according to the invention, the sugar and/or sugar substituent comprises brown sugar, caster sugar, granulated sugar, icing sugar, melis, erythritol, maltitol, acesulfame potassium, stevia, sucralose, or a combination thereof.

An advantage of the sugar is that sufficient binding with the baking paper is achieved. As a result, the coating composition according to the invention may be used multiple times before the baking paper including the coating composition is disposed of. Furthermore, the sugar influences the viscosity, such that the desired viscosity may be achieved.

In further preferred embodiment according to the invention, the fat may have a melting temperature of at least 20° C., preferably between 20° C. and 120° C., more preferably between 25° C. and 100° C. Preferably, the fat comprises cacao butter and/or palm oil and/or sunflower oil.

Providing a fat with a melting temperature of at least 20° C., preferably between 20° C. and 120° C., more preferably between 25° C. and 100° C. enables an efficient and effective coating composition. Furthermore, this enables the fat to be liquid during mixing of the different compounds of the coating composition according to the invention. As a result, the fat is evenly distributed throughout the coating composition.

It was found that cacao butter and/or palm oil and/or sunflower oil enable efficient and effective release of a print which has been provided to the coating composition. In addition, said release may be induced by applying heat to the baking paper comprising the coating composition according to the invention and a print/figure, and the like.

In further preferred embodiment according to the invention, the wax comprises beeswax, candelilla wax, carnauba wax, shellac, paraffins, microcrystalline wax, crystalline wax, rice bran wax, lanolin, oxidized polyethylene wax, esters of colophony, or a combination thereof.

It was found that in particular beeswax provides an efficient and effective coating composition. In addition, the wax enables the coating composition according to the invention to be evenly distributed over a surface, for example a surface of the baking paper.

In further preferred embodiment according to the invention, the coating composition further comprises an additive. Preferably, the additive comprises calcium carbonate, calcium bicarbonate, titanium dioxide, or a combination thereof.

An advantage of an additive is that properties of the coating composition may be tuned, such that the desired coating composition is achieved. For example, calcium carbonate, calcium bicarbonate, titanium dioxide, or a combination thereof enable to achieve a substantially white coating composition.

In further preferred embodiment according to the invention, the coating composition further comprises a thickener. Preferably, the thickener comprises bamboo fibres, locust bean gum, oat gum, gum arabic, alginic acid, sodium alginate, potassium alginate, ammonium alginate, calcium alginate, propane-1,2-diol alginate, agar, carrageenan, guar gum, tragacanth, xanthan gum, karaya gum, tara gum, gellan gum, or a combination thereof.

Providing a thickener enables to further tune the viscosity, such that the desired viscosity is achieved. In addition, a thickener may provide the desired structure to the coating composition when applied to baking paper. For example, the coating composition may have a smooth upper surface. The upper surface is defined as the surface which extends away from the baking paper. In other words, the surface which is not attached to the baking paper.

Preferably, when bamboo is used, the bamboo fibres have a length of about 300 mu.

In further preferred embodiment according to the invention, the coating composition further comprises an aroma. Preferably, the aroma comprises a cream aroma and/or a vanilla aroma.

An advantage of the aroma is that the taste of the coating composition increases. Furthermore, it was found that an aroma may mask undesired smells of the coating composition.

A further advantage is that an aroma may increase the look, feel, and smell of coated baking paper for someone who uses said baking paper.

In further preferred embodiment according to the invention, the fat may be present in an amount in the range of 7 wt. % to 11 wt. %, and/or the amorphous starch may be present in an amount in the range of 9 wt. % to 14 wt. %, and/or the sugar and/or sugar substituent may be present in an amount in the range of 7 wt. % to 11 wt. %, and/or the emulsifier may be present in an amount in the range of 1 wt. % to 4 wt. %, and/or the wax may be present in an amount in the range of 1 wt. % to 4 wt. %. Preferably, the honey may be present in an amount in the range of 1 wt. % to 4 wt. %, and/or the additive may be present in an amount in the range of 1 wt. % to 4 wt. %, and/or the thickener may be present in an amount in the range of 3 wt. % to 8 wt. %, and/or the aroma may be present in an amount in the range of 1 wt. % to 3 wt. %.

It is noted that throughout this application wt. % refers to weight percentage and that the amount of each individual compound provided to the coating composition is a weight percentage of the total composition. In other words, the total amount of the compounds of the coating composition according to the invention is including the amount of water.

Experiments showed that providing a coating composition comprising the compounds in the above mentioned amounts, an efficient and effective coating composition according to the invention is achieved.

In further preferred embodiment according to the invention, the fat comprises cacao butter, amorphous starch comprises amorphous tapioca and amorphous potato starch, the sugar and/or sugar substituent comprises caster sugar, the emulsifier comprises lecithin, glycerol and polyoxyethylene (20) sorbitan monolaurate, and the wax comprises beeswax. Preferably, the honey comprises nectar honey, more preferably the additive comprises calcium carbonate.

In a preferred embodiment the thickener comprises gellan gum and bamboo fibres. Preferably, the aroma comprises vanilla aroma.

Said combination of compounds provide an efficient and effective coating composition. Furthermore, said coating composition showed that excellent transfer of a print/ink is achieved.

The invention also relates to coated baking paper, comprising baking paper and coating composition according to the invention, wherein the coating composition is cured to form a coating which comprises at most 20 wt. % of water. Preferably, the coated baking paper further comprises a print configured on the coating, wherein the print may be made of edible ink.

It is noted that after curing of the coating composition the weight ratio of the compounds part of the coating composition according to the invention changes accordingly.

The coated baking paper provides the same or similar effects and advantages as those described for the coating composition according to the invention.

The coated baking paper according to the invention enables an efficient and effective transfer sheet for a print and/or ink.

In a preferred embodiment according to the invention, the coated baking paper further comprises at least 40 grams of cured coating composition per square metre, preferably comprising 45 grams of cured coating composition per square metre to 100 grams of cured coating composition per square metre.

It was found that coated baking paper comprising at least 40 grams of cured coating composition per square metre, preferably comprising 45 grams of cured coating composition per square metre to 100 grams of cured coating composition per square metre enables an efficient and effective transfer of a print and/or ink.

The invention also relates to a method for making a coating composition according to the invention, comprising the steps of:
mixing water, starch, sugar and/or sugar substituent, fat, emulsifier, and wax in a reactor, providing a mixture; and
fermenting the mixture for at least 3 hours.

The method for making the coating composition according to the invention provides the same or similar effects and advantages as those described for the coating composition according to the invention, and the coated baking paper according to the invention.

It is noted that making the coating composition according to the invention also refers to manufacturing or producing the coating composition according to the invention.

The step of mixing water, starch, sugar and/or sugar substituent, fat, emulsifier, and wax in a reactor includes mixing starch, wherein the starch is preferably potato starch and/or corn starch and/or tapioca.

Fermenting the mixture enables to provide the coating composition according to the invention. As a result, the fermenting of the starch provides an efficient and effective coating composition for baking paper.

In a preferred embodiment according to the invention, the step of mixing comprises the steps of:
heating the fat, the wax, and at least part of the emulsifier; and
adding the heated fat, wax and at least part of the emulsifier to the mixture.

In further preferred embodiment according to the invention, the method further comprises the step of adding honey, and/or amylse, and/or additive, and/or thickener, and/or aroma to the mixture.

Adding honey and/or amylase induces and/or accelerates the fermentation of starch. Therefore, the desired amorphous starch is achieved in an efficient and effective manner.

In further preferred embodiment according to the invention, the step of fermenting may be performed for at least 4 hours, preferably for at least 5 hours, more preferably for at least 6 hours, even more preferably for at least 7 hours, most preferably for at least 8 hours. Preferably, the step of fermenting is performed for at most 12 hours.

It was found that sufficient fermentation of starch into amorphous starch is achieved for a fermentation process of at most 12 hours.

In a further preferred embodiment according to the invention, the step of fermenting may be performed at a temperature in the range of 40° C. to 80° C., preferably in the range of 50° C. to 70° C., more preferably in the range of 55° C. to 65° C., most preferably about 60° C.

The invention also relates to a method for making a coated baking paper according to the invention, comprising the steps of:
providing baking paper;
coating the baking paper; and
curing the coated baking paper to form a coating which comprises at most 20 wt. % of water.

The method for making a coated baking paper according to the invention provides the same or similar effects and advantages as those described for the coating composition according to the invention, the coated baking paper according to the invention, and the method for making a coating composition according to the invention.

Curing of the coated baking paper may be performed using heat and/or drying time. For example, heating the coated baking paper to a temperature in the range of 30° C. to 60° C. and/or providing a drying time in range of 1 minute to 30 minutes.

The drying of the coating composition may for example be accelerated using a ventilator and/or a drying tunnel, wherein the drying tunnel enables a controlled environment for drying the coated baking paper.

In a preferred embodiment according to the invention, wherein the baking paper may be coated on one side.

Coating the baking paper on one side enables efficient packaging, wherein multiple sheets of baking paper do not stick to each other.

In a further preferred embodiment according to the invention, the method comprises the step of printing on the coated baking paper.

Providing the coated baking paper with a print/ink enables to transfer said print/ink to an edible substrate.

The invention also relates to a use of the coated baking paper according to the invention, to provide a print to an edible product.

The use of the coated baking paper according to the invention provides the same or similar effects and advantages as those described for the coating composition according to the invention, the coated baking paper according to the invention, the method for making a coating composition according to the invention, and method for making a coated baking paper according to the invention.

Further advantages, features and details of the invention are elucidated on the basis of preferred embodiments thereof, wherein reference is made to the accompanying drawings, in which:

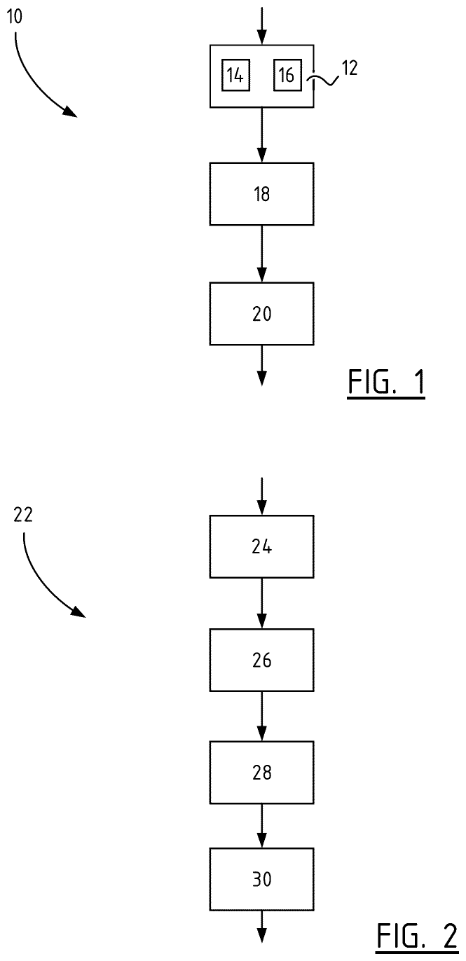

FIG. 1 shows a schematic overview of the method for making a coating composition according to the invention; and

FIG. 2 shows a schematic overview of the method for making a coated baking paper according to the invention.

Method 10 (FIG. 1) for making a coating composition according to the invention follows a sequence of different steps.

In the illustrated embodiment method 10 may start with step 12 of mixing water, starch, sugar and/or sugar substituent, fat, emulsifier, and wax in a reactor, providing a mixture. Step 12 may comprise two sub-steps, step 14 of heating the fat, the wax, and at least part of the emulsifier and/or step 16 of adding the heated fat, wax, and at least part of the emulsifier to the mixture.

Step 12 may be followed by step 18 of adding honey, and/or amylse, and/or additive, and/or thickener, and/or aroma to the mixture. Before step 20 of fermenting the mixture for at least 3 hours is performed the mixture comprising all the compounds might be mixed before the fermenting is started. Furthermore, the mixture may be preheated from the start of step 12.

Method 22 (FIG. 2) for making a coated baking paper according to the invention follows a sequence of different steps.

In the illustrated embodiment method 22 may start with step 24 of providing baking paper, followed by step 26 of coating the baking paper. The coated baking paper may be cured by step 28 of curing the coated baking paper to form a coating which comprises at most 20 wt. % of water. Curing of the coated baking paper may be performed using heat and/or drying time.

Step 28 may be followed by step 30 of printing on the coated baking paper. The coated baking paper comprising the print may be used to provide a print to an edible product, wherein said product may be consumed by a human.

Experiments showed that an efficient and effective coating composition was achieved.

Table 1 shows an example of the coating composition according to the invention

| Component | Amount before fermentation | Amount after fermentation |
|---|---|---|
| Water | 2500 grams | 2500 grams |
| Caster sugar | 400 grams | 400 grams |
| Cacao butter | 400 grams | 400 grams |
| Tapioca | 300 grams | |
| Amorphous tapioca | | 300 grams |
| Potato starch | 200 grams | |
| Amorphous potato starch | | 200 grams |
| Bamboo fibres (300 mu) | 150 grams | 150 grams |
| Nectar honey | 100 grams | 100 grams |
| Calcium carbonate | 50 grams | 50 grams |
| Aroma | 50 grams | 50 grams |
| Polyoxyethylene (20) sorbitan | 50 grams | 50 grams |
| monolaurate | | |
| Beeswax | 50 grams | 50 grams |
| Gellan gum | 30 grams | 30 grams |
| Glycerol | 20 grams | 20 grams |
| Lecithin | 20 grams | 20 grams |

In a further experiment, 40 Litres of water were provided to a first reactor together with 3000 grams of Amylogum™ and 250 grams of glycerol, providing a mixture. Said mixture was heated to 115° C., until a clear mixture was achieved. To the clear mixture, 2000 grams of caster sugar was added, and the reactor was heated to about 60° C.

In a second reactor, 2000 grams cocao butter, 40 grams of lecithin, 250 grams of beeswax, and optionally 50 grams of aroma were mixed at 80° C. The resulting mixture was added to the mixture in the first reactor, together with 1000 grams of tapioca, 750 grams of bamboo fibres (300 mu), 50 grams of gellan gum, and 800 grams of nectar honey.

The first reactor was closed, and the mixture was slowly stirred for 10 hours at about 60° C., such that the mixture is enabled to ferment.

In a further experiment, 40 Litres of water were provided to a first reactor together with 3000 grams of agar-gom and 250 grams of glycerol, providing a mixture. Said mixture was heated to 115° C., until a clear mixture was achieved. To the clear mixture, 2000 grams of caster sugar was added, and the reactor was heated to about 60° C.

In a second reactor, 2000 grams cocao butter, 40 grams of lecithin, 250 grams of beeswax, and optionally 50 grams of aroma were mixed at 80° C. The resulting mixture was added to the mixture in the first reactor, together with 1000 grams of tapioca, 750 grams of bamboo fibres (300 mu), 50 grams of gellan gum, and 800 grams of nectar honey.

The first reactor was closed, and the mixture was slowly stirred for 10 hours at about 60° C., such that the mixture is enabled to ferment.

In a further experiment, 40 Litres of water were provided to a first reactor together with 3000 grams of Amylogum™ and 250 grams of glycerol, providing a mixture. Said mixture was heated to 115° C., until a clear mixture was achieved. To the clear mixture, 2000 grams of caster sugar was added, and the reactor was heated to about 60° C.

In a second reactor, 2000 grams palm oil, 40 grams of lecithin, 250 grams of beeswax, and optionally 50 grams of aroma were mixed at 80° C. The resulting mixture was added to the mixture in the first reactor, together with 1000 grams of tapioca, 750 grams of bamboo fibres (300 mu), 50 grams of gellan gum, and 800 grams of nectar honey.

The first reactor was closed, and the mixture was slowly stirred for 10 hours at about 60° C., such that the mixture is enabled to ferment.

In a further experiment, 40 Litres of water were provided to a first reactor together with 3000 grams of Amylogum™ and 250 grams of glycerol, providing a mixture. Said mixture was heated to 115° C., until a clear mixture was achieved. To the clear mixture, 2000 grams of caster sugar was added, and the reactor was heated to about 60° C.

In a second reactor, 1500 grams cacao butter, 500 grams of sunflower oil, 40 grams of lecithin, 250 grams of beeswax, and optionally 50 grams of aroma were mixed at 80° C. The resulting mixture was added to the mixture in the first reactor, together with 1000 grams of tapioca, 750 grams of bamboo fibres (300 mu), 50 grams of gellan gum, and 800 grams of nectar honey.

The first reactor was closed, and the mixture was slowly stirred for 10 hours at about 60° C., such that the mixture is enabled to ferment.

It was found that a coating composition comprising cacao butter provided the most efficient and effective composition for baking paper.

The present invention is by no means limited to the above described preferred embodiments and/or experiments thereof. The rights sought are defined by the following claims within the scope of which many modifications can be envisaged.

1. A coating composition for baking paper, comprising a fat, an amorphous starch, at least one of a sugar and a sugar substituent, an emulsifier, and a wax.

2. The coating composition of claim 1, further comprising a honey, wherein the honey is at least one of nectar honey, and honeydew honey, and wherein the honey is present in an amount in the range of 1 wt. % to 4 wt. %.

3. (canceled)

4. The coating composition of claim 1, further comprising an amylase.

5. The coating composition of claim 4, wherein the amylase is at least one of α-amylase, β-amylase, and γ-amylase.

6. The coating composition of claim 1, further comprising water, wherein the water has a hardness in the range of 1 ppm to 180 ppm, and wherein the water is present in an amount in the range of 50 wt. % to 65 wt. %.

7. (canceled)

8. (canceled)

9. The coating composition of claim 1, wherein the emulsifier comprises at least one of lecithin, glycerol, polyoxyethene (8) stearate, polyoxyethene (40) stearate, polyoxyethylene (20) sorbitan monolaurate, polyoxyethylene (20) sorbitan monopalmitate, polyoxyethylene (20) sorbitan monostearate, polyoxyethylene (20) sorbitan monooleate, polyoxyethene (20) sorbitan tristearate, alginic acid, sodium alginate, potassium alginate, ammonium alginate, calcium alginate, propane-1,2-diol alginate, carrageenan, processed eucheuma seaweed, locust bean gum, tragacanth, gum arabic, karaya gum, and gellan gum.

10. (canceled)

11. The coating composition of claim 1, further comprising a modified starch, wherein the modified starch comprises a phosphate carbamate ester, and further comprising an additive, wherein the additive comprises at least one of calcium carbonate, calcium bicarbonate, and titanium dioxide, and wherein the additive is present in an amount in the range of 1 wt. % to 4 wt. %.

12. (canceled)

13. The coating composition of claim 1, wherein the fat has a melting temperature of at least 20° C., and wherein the wherein the fat comprises at least one of cacao butter, palm oil, and sunflower oil.

14. (canceled)

15. The coating composition of claim 1, wherein the wax comprises at least one of beeswax, candelilla wax, carnauba wax, shellac, paraffins, microcrystalline wax, crystalline wax, rice bran wax, lanolin, oxidized polyethylene wax, and esters of colophony.

16. (canceled)

17. (canceled)

18. The coating composition of claim 1, further comprising a thickener, wherein the thickener comprises at least one of bamboo fibres, locust bean gum, oat gum, gum arabic, alginic acid, sodium alginate, potassium alginate, ammonium alginate, calcium alginate, propane-1,2-diol alginate, agar, carrageenan, guar gum, tragacanth, xanthan gum, karaya gum, tara gum, and gellan gum, and wherein the thickener is present in an amount in the range of 3 wt. % to 8 wt. %.

19. (canceled)

20. The coating composition of claim 1, further comprising an aroma, wherein the aroma comprises at least one of a cream aroma and a vanilla aroma, and wherein the aroma is present in an amount in the range of 1 wt. % to 3 wt. %.

21. (canceled)

22. The coating composition of claim 1, wherein the fat is present in an amount in the range of 7 wt. % to 11 wt. %, wherein the wherein the amorphous starch is present in an amount in the range of 9 wt. % to 14 wt. %, wherein the at least one of the sugar and the sugar substituent is present in an amount in the range of 7 wt. % to 11 wt. %, wherein the emulsifier is present in an amount in the range of 1 wt. % to 4 wt. %, and wherein the wax is present in an amount in the range of 1 wt. % to 4 wt. %.

23. (canceled)

24. (canceled)

25. (canceled)

26. (canceled)

27. (canceled)

28. (canceled)

29. (canceled)

30. (canceled)

31. The coating composition of claim 1, wherein the fat comprises cacao butter, wherein the amorphous starch comprises amorphous tapioca and amorphous potato starch, wherein the at least one of the sugar and the sugar substituent comprises caster sugar, wherein the emulsifier comprises lecithin, glycerol and polyoxyethylene (20) sorbitan monolaurate, wherein the wax comprises beeswax, wherein the coating composition further comprises at least one of nectar honey, an additive, a thickener and an aroma, wherein the additive comprises calcium carbonate, wherein the thickener comprises at least one of gellan gum and bamboo fibres, wherein the aroma comprises a vanilla aroma.

32. (canceled)

33. (canceled)

34. (canceled)

35. (canceled)

36. A coated baking paper comprising a baking paper and a coating composition, wherein the coating composition comprises a fat, an amorphous starch, at least one of a sugar and/or and a sugar substituent, an emulsifier, and a wax, wherein the coating composition is in the cured form which comprises at most 20 wt. % of water.

37. The coated baking paper of claim 36, further comprising a print on the coating, wherein the print is made of edible ink, and wherein the coated baking paper further comprises at least 40 grams of cured coating composition per square metre.

38. (canceled)

39. A method for making a coating composition comprising the steps of:
mixing water, a starch, at least one of a sugar and a sugar substituent, a fat, an emulsifier, and a wax in a reactor, providing a mixture; and
fermenting the mixture for at least 3 hours.

40. The method of claim 39, wherein the step of mixing comprises the steps of:
heating the fat, the wax, and at least part of the emulsifier;
adding the heated fat, wax, and at least part of the emulsifier to the mixture, and
adding at least one of a honey, an amylse, an additive, a thickener, and an aroma to the mixture.

41. (canceled)

42. The method of claim 39, wherein the step of fermenting is performed for at most 12 hours, and wherein the step of fermenting is performed at a temperature in the range of 40° C. to 80° C.

43. (canceled)

44. (canceled)

45. The method of claim 39, comprising the steps of:
providing baking paper;
coating the baking paper; and
curing the coated baking paper to form a coating which comprises at most 20 wt. % of water.

46. The method of claim 45, wherein the baking paper is coated on one side and wherein the method further comprises the step of printing on the coated baking paper.

47. (canceled)

48. (canceled)
